(19) United States
(12) Patent Application Publication
(10) Pub. No.: US 2022/0097038 A1
(43) Pub. Date: Mar. 31, 2022

(54) PIPETTING HEAD, PIPETTING DEVICE COMPRISING A PIPETTING HEAD, AND METHOD FOR PIPETTING USING A PIPETTING HEAD

(71) Applicant: Eppendorf AG, Hamburg (DE)

(72) Inventors: Jens Wilmer, Hamburg (DE); Dominik Schneider, Hamburg (DE)

(73) Assignee: Eppendorf AG, Hamburg (DE)

(21) Appl. No.: 17/413,730

(22) PCT Filed: Dec. 12, 2019
(86) PCT No.: PCT/EP2019/084908

§ 371 Date: Jun. 14, 2021

(30) Foreign Application Priority Data
Dec. 14, 2018 (EP) 18212800.9

(51) Int. Cl. B01L 3/02

(52) U.S. Cl. CPC B01L 3/0275; B01L 2300/0829; B01L 2200/022; B01L 2300/123; B01L 2200/026; B01L 2200/0689; B01L 2300/0609; B01L 2200/025

(57) ABSTRACT

A pipetting head comprises a carrier, at least one attachment held on the carrier and configured to secure at least one pipette tip, and two O-rings retained on the at least one attachment and configured to contact the sealing seat of the at least one pipette tip. The inner diameter of the sealing seat of the at least one pipette tip is smaller than an outer diameter of a respective O-ring where the sealing seat contacts a respective O-ring. The respective O-ring is deformed while the pipette tip is slid onto the at least one attachment to securely clamp the at least one pipette tip. The sealing seat of the at least one pipette tip is dimensioned such that the at least one attachment exerts a force on the pipette tip to deform the at least one pipette tip when it is securely clamped on the at least one attachment.

### CROSS REFERENCE TO RELATED INVENTION

This application is a national stage application pursuant to 35 U.S.C. § 371 of International Application No. PCT/EP2019/084908, filed on Dec. 12, 2019, which claims priority to, and benefit of, European Patent Application No. 18212800.9, filed Dec. 14, 2018, the entire contents of which are hereby incorporated by reference.

### FIELD OF TECHNOLOGY

The invention relates to a pipetting head for picking up pipette tips, to a pipetting device comprising a pipetting head, and to a method for pipetting liquids using a pipetting head.

### BACKGROUND

Pipetting devices with a pipetting head for picking up a single or for simultaneously picking up a plurality of pipette tips are used in particular in medical, biological, biochemical, and chemical laboratories for metering liquids.

Pipetting heads have at least one attachment that can be inserted into a mounting opening on the top end of a pipette tip. Liquid is drawn into the pipette tip and discharged therefrom through a tip opening at the bottom end of the pipette tip. After use, the pipette tip can be detached from the attachment and exchanged for a fresh pipette tip. In this way, contamination of the subsequent meterings can be avoided. Pipette tips consisting of plastic are economically available for single use.

When configured as an air cushion pipetting device, at least one displacement apparatus for air is integrated in the pipetting device and connected via a connecting hole in each attachment to communicate with a pipette tip clamped thereon. By means of the displacement apparatus, an air cushion can be shifted so that liquid is sucked into, and ejected out of, the pipette tip. The displacement apparatus is typically a cylinder with a plunger which can move therein. However, displacement apparatuses are also known with a displacement chamber and at least one deformable wall, wherein a deformation of the wall causes the displacement of the air cushion.

In the embodiment as a direct displacement pipetting device, a small plunger is arranged in the pipette tip that is coupled to a plunger drive of the pipetting device when the pipette tip is mounted on the attachment. The liquid is preferably drawn in a single step or in several small steps. The liquid is dispensed in a single step when pipetting, and discharged in several small steps when dispensing. The pipetting devices can be configured as practical multichannel pipettes that are driven manually or by electric motor and are held in the hand of the user when pipetting (“hand-held pipettes”).

In metering stations (“pipetting stations”) or metering machines (“pipetting machines”), the pipetting head can be shifted on a robot arm or another transferring system to shift the pipetting head above a work surface. Metering stations or metering machines can pick up fresh pipette tips from a holder by the pipetting head, draw liquids from vessels and discharge them into vessels by the pipette tips, and discard used pipette tips into a waste container. Pipetting heads can be a component of laboratory machines (“workstations”) that can perform other procedures with liquids beyond the metering of liquids. This includes in particular mixing, controlling temperature and other physical procedures, chemical or biochemical conversion, and the analysis of specimens.

The attachments for holding pipette tips are frequently designed as a conical, cylindrical, or partially conical and partially cylindrical projection relative to a housing or another carrier of the pipetting device. Pipette tips can be clamped on to an attachment by a sealing seat at their top end adjacent to a mounting opening. For this purpose, at least one attachment is pressed into the mounting opening of at least one pipette tip available in a holder so that the pipette tip expands somewhat and sits securely on the attachment under pre-tension. The force to be applied for clamping increases with the number of pipette tips.

To detach the clamped-on pipette tip from the attachment, the pipetting devices have an ejection apparatus with a drive apparatus and an ejector. By actuating the drive apparatus, the ejector is shifted so that it detaches the pipette tip from the attachment. The drive apparatus is either driven manually or by an electric motor. The ejection force for detaching clamped-on pipette tips from the attachment increases with the number of pipette tips. +Strong forces must be applied to clamp pipette tips onto 8, 12, 16, 24, 96 or 384 attachments and to eject the pipette tips from the attachments.

DE 10 2004 003 433 134 describes a multichannel pipette in which the applied force for clamping the pipette tips onto the attachments and detaching the pipette tips from the attachments is reduced in that the attachments are spring-loaded and project in an axial direction beyond a stop formed by the ejector. If the clamping force exceeds a specific value when clamping on the pipette tips, the attachments yield until the pipette tips lie on the ejector. This limits the clamping force to a value at which the pipette tips are sealingly held on the attachments. The ejection force is also correspondingly limited.

EP 2 735 369 A1 describes a multichannel pipette in which the ejector serves as a stop element when the pipette tips are slid on to the attachments. The ejection forces are further reduced in that the ejector has a plurality of contact elements that sequentially contact the pipette tips in order press them off the attachments.

WO 01/56695 A1 describes a pipetting head with 96 channels, wherein the attachments have a greater conical angle at the bottom end than above in order to reduce the force for mounting pipette tips with a collar having a greater wall thickness at the top end and a lesser wall thickness below the collar. The pipetting head comprises a stop plate for ejecting the pipette tips from the attachments. The stop plate is stepped in order to sequentially press off the pipette tips from the attachments and reduce the ejection force. Posts with pretensioning apparatuses project from the stop plate. A plunger plate that shifts plungers in cylinders connected to the attachments contacts the pretensioning apparatuses when retracting in order to trigger the ejection of the pipette tips from the attachments by the stop plate. The design with pretensioning apparatuses to eject pipette tips is complex.

WO 2005/113149 A1 and DE 20 2005 006 970 U1 describe a device for drawing and dispensing liquids with a pipetting head that has 96 attachments for pipette tips. 96 plunger/cylinder units are connected to the attachments and can be manually actuated using a drive mechanism. The pipetting head can be shifted along a vertical guide in order to pick up pipette tips from a pipette tip carrier and suck in and dispense liquid. The pipetting head can be pressed downward with greater force by means of a transmission lever in order to apply the necessary force for picking up 96 pipette tips. The attachments are guided through holes in a perforated plate that is vertically shiflable in order to strip the pipette tips off the attachments.

DE 20 2008 013 533 U1 describes a pipetting device with a base plate and an elastic sealing plate that covers it laterally on the outside, wherein a plurality of pipetting channels arranged in a given pattern extend through the baseplate and the sealing plate. A magazine equipped with pipette tips in the same pattern that each have a collar lies in a magazine holder to directly connect to the base plate in a force fit via the collars and the sealing plate. The magazine holder is formed by a magazine frame that can be raised and lowered by a drive motor via an eccentric gearing in order to bring the pipette tips into scaling contact with the sealing plate, or to detach them from the sealing plate.

Pipetting machines that receive the pipette tips in a magazine in a magazine holder and press them against a sealing plate are marketed by the company Apricot Designs, Inc, Covina, Calif., USA, under the product name of “i-Pipette” and “i-Pipette Pro.” The disadvantage is that these pipetting machines can only work with special pipette tips in a special magazine. It is furthermore disadvantageous that the magazine holder is filled manually.

EP 0 337 726 A2 describes a device for simultaneously picking up a plurality of pipette tips by means of parallel attachments in a straight row that each have an elastomer O-ring in an annular groove with an adjustable groove width. The extension of the O-rings in the peripheral direction can be changed by adjusting the groove widths in order to sealingly clamp tight the pipette tips on the attachments and detach the pipette tips from the attachments. In order to adjust the groove widths, the grooves are each bordered by a threaded sleeve that is screwed onto the attachment and can be turned on the attachment by means of a coupled drive mechanism. Each threaded sleeve is securely connected to a toothed wheel. The toothed wheels mesh with a single rack that is driven by a rotatable handgrip. In an alternative embodiment, each individual threaded sleeve is individually driven by an electric motor, and the electric motors are connected to a common power supply for synchronous operation. The drive for securely clamping the pipette tips to the attachments has a complicated design.

DE 199 17 375 C2 describes a pipetting unit with a pipette tip and an attachment that has a pipette tube with a coupling sleeve at the bottom end, an O-ring that is slid onto the pipette tube and consists of an elastically deformable material, and a sleeve slid onto the pipette tube. The sleeve serves to axially compress the O-ring so that it is deformed radially and engages sealingly in an annular groove in the inner perimeter of the pipette tip. The O-ring can be relieved to detach the pipette tip. To hold the pipette tip on the attachment in a predetermined position, the attachment and pipette tip have interacting axial positioning means. Since the O-ring engages in an annular groove in the pipette tip, the axial positioning means that adjoin each other are pretensioned. To eject the pipette tip, a movable ejector is provided that is formed as an ejector tube surrounding the sleeve. The ejector is actuatable hydraulically or by an electric motor, or by means of a preloaded spring that is tensioned while mounting the pipette tip on the pipetting unit. The actuating means for securely clamping and detaching the pipette tip on the attachment are complex and have a large space requirement. Affixing the pipette tips in the defined coupling position can be easily prevented by production tolerances or imprecisely positioning the pipette tips on the attachment. The annular groove and the axial positioning means restrict the use of various pipette tips.

WO 2018/002254 A1 and DE 10 2016 111 912 A1 describe a metering head for a metering device with a carrier on which a plurality of parallel attachments for receiving pipette tips is arranged next to each other. Each attachment has a tube with an at least partially peripheral supporting projection that protrudes outward from the outer perimeter at the bottom end, at least one sleeve which surrounds the tube and can be axially shifted on the tube, and at least one elastomer O-ring which surrounds the tube and is arranged near the bottom end of the sleeve. Above the sleeves, a pressure plate is arranged which has a plurality of first holes through which the tubes extend, wherein the pressure plate can be shifted along the tubes between a release position at a first distance from the supporting projections and a clamping position at a second distance from the supporting projections that is smaller than the first distance, the pressure plate presses against the upper edge of the adjacent sleeves of all attachments in the clamping position in such a way that the sleeves are pressed, at the bottom ends, against the adjacent O-rings, and the O-rings are expanded in order to securely clamp pipette tips slid onto the attachments. A first shifting apparatus is connected to the pressure plate and is designed to shift the pressure plate between the release position and the clamping position.

Simultaneously securely clamping and releasing a large number of pipette tips is enabled by simultaneously pressing the pressure plate against all the sleeves, and by simultaneously releasing all the sleeves. The transmission of force from the first adjusting device via the pressure plate to the sleeves promotes a comparatively simple, compact and light construction. Clamping securely by expanding the O-rings promotes the use of pipette tips with different shapes and dimensions.

DE 10 2006 036 764 describes a pipetting system with a pipetting device with at least one mounting shaft which has a peripheral latching bead on the outer perimeter and, beneath that, two peripheral annular grooves spaced apart from each other, which each accommodate a sealing ring. The pipetting system comprises a pipette tip that can be clamped onto the latching bead with a latching groove and beneath that has a sealing region against which the sealing rings lie in a sealing manner. The latching achieves a defined seat of the pipette tip on the mounting shaft and the sealing rings seal the pipette tip against the mounting shaft. To latch the latching bead and latching groove, relatively high mounting forces are required.

Starting from this, the object of the invention is to provide a pipetting head with at least one attachment and at least one pipette tip for securely picking up and detaching the pipette tip on the attachment with reduced force and reduced design complexity.

### BRIEF SUMMARY OF THE INVENTION

In an embodiment, a pipetting head with at least one pipette tip for a pipetting device comprises a carrier, at least one attachment held on the carrier for clamping on pipette tips, and two elastomer O-rings held on the attachment. At the point that contacts an O-ring, the inner diameter of a scaling seat of the pipette tip is smaller than the outer diameter of the respective O-ring so that the latter is deformed while being slid on and securely clamps the pipette tip on the attachment. The inner dimensions of a sealing seat of the pipette tip are dimensioned so that the scaling seat has no direct contact with the attachment or lies against the attachment without the attachment exerting a force on the pipette tip that deforms the latter, when the pipette tip is securely clamped on the attachment through deformation of the two O-rings.

Pipette tips are long tubes that have a tip opening on their bottom end and a sealing seat at their top end, adjacent to a mounting opening, with which they can be clamped to the attachment. The inner diameter and the outer diameter of the pipette tips generally expand from the tip opening to the mounting opening, if a pipette tip is picked up by an attachment of a pipetting head that does not have an O-ring, has only one O-ring, or has one latching bead and two O-rings, high pick-up forces (mounting forces, clamping forces) occur since the pipette tip consisting of polypropylene, polyethylene, or another hard-elastic plastic comes into direct contact with the attachment when being slid onto the attachment and is thereby deformed. Since in the pipetting head according to the invention the two O-rings, the attachment, and the pipette tip are configured so that a pipette tip can be securely clamped to the attachment through a deformation of the two O-rings caused only by pressing the pipette tip onto the two O-rings, a direct contact of the pipette tip with the attachment is avoided through which the pipette tip is expanded. In this case, either the pipette tip has no direct contact with the attachment or only lies against the attachment without a force that deforms the pipette tip acting between the attachment and the pipette tip. As a result of this, when the pipette tips are picked up by the pipetting head, only the two O-rings are deformed. In doing so, the pipette tip is not clamped directly onto the attachment through expansion, but rather by means of the two O-rings, which are held on the attachment and lie against the pipette tip under pretension due to their deformation. Since the O-rings are comprised of an elastomer, they can be more easily deformed than the pipette tip. As a result, the pick-up force required to pick up the pipette tips is reduced. In the case of a hand-held pipette, reducing the clamping forces can reduce the strain for the user during manual pipetting. In the case of a pipetting station, a pipetting machine, or a laboratory machine, this lowers the requirements placed on the transferring system, in particular its strength and the performance of the drives.

In addition, the two O-rings cause a precise alignment of the pipette tips on the attachment. This is advantageous for the introduction of pipette tips into the openings of vessels without colliding with the vessels. As a result, in particular a tipping of the pipette tip can be avoided when, in the case of hand-held pipetting, the bottom end of the pipette tip contacts the wall of the vessel. This is recommended by the pipette manufacturer so that the liquid runs out of the tip opening under uniform conditions.

A further advantage of the two O-rings on each attachment is that all the tips can be slid onto the attachment so that they can be pushed even farther up on the attachment at a subsequent time and are pushed up farther into a position for pipetting later. Alternatively, all the tips can be pressed up on the attachment up to an ejector or stop so that the clamped-on pipette tips are always at the same height.

In an embodiment, at the point that contacts an O-ring, the inner diameter of the sealing seat of the pipette tip is smaller than the outer diameter of the respective O-ring so that said O-ring is deformed while being slid on and securely clamps the pipette tip on the attachment. Furthermore, the inner dimensions of a sealing seat of the pipette tip are dimensioned so that the sealing seat has no direct contact with the attachment or lies against the attachment without the attachment exerting a force on the pipette tip that deforms it, when the pipette tip is securely clamped on the attachment through deformation of the two O-rings.

According to another embodiment, the sealing seat has a circular-cylindrical shape or a conical shape that expands toward the mounting opening. According to another embodiment, the inner diameter of the sealing seat is larger than or the same size as the outer diameter that the attachment has in the same cross-sectional plane as the sealing seat when the pipette tip is securely clamped on the attachment through deformation of the two O-rings.

According to an embodiment, the pipette tips can be securely clamped to the attachment in a sealing manner so that the pipetting head can be used to draw in and dispense liquid by means of at least one clamped-on pipette tip. For this purpose, the pipetting head has at least one displacement apparatus which is connected to a connecting hole at the end of the attachment via at least one line in order to displace an air cushion and to draw liquid into a clamped-on pipette tip through the tip opening and dispense it therefrom. Due to the radial deformability of the two O-rings, it is possible to pick up pipette tips with different dimensions on the same attachment and to pipette with the variously sized pipette tips. As a result, the complexity of performing various pipetting tasks can be reduced. For example, the O-rings and the attachment can be configured so that pipette tips with a nominal volume of 10 μl and 50 μl or with a nominal volume of 300 μl and 1,000 μl can be clamped onto the same attachment in a sealing manner. For this purpose, commercially available pipette tips from various manufacturers can be used since they have matching dimensions in the sealing region.

If the dimensions of the various pipette tips differ greatly, the pipetting head can, if necessary, be used to transfer pipette tips of various sizes, e.g. from one pipette tip carrier to another pipette tip carrier, since the pipette tips, although they are not securely clamped to the attachments in a sealing manner, sit so securely on the attachments that they can be transferred by means of the pipetting head. This can be used in particular for the automatic transfer of pipette tips in a laboratory machine. For example, the O-rings and the attachment can be configured so that commercially available pipette tips with a nominal volume of 10, 50, 300, and 1,000 μl can be picked up and transferred with the same attachment. The invention comprises pipetting heads that can be used for transferring pipette tips, but not for drawing in and dispensing liquids. Such a pipetting head for transferring pipette tips can be configured without a displacement apparatus and will in the following also be referred to as a transfer head.

According to another embodiment, the O-rings are manufactured from a soft elastomer. According to another embodiment, the O-rings are manufactured from rubber, silicone rubber, fluorine rubber (FEPM—for example Viton® from DuPont Performance Elastomers), hydrated nitrile rubber (HNBR), ethylene propylene diene monomer rubber (EPDM), or a thermoplastic elastomer. O-rings made of a soft elastomer (silicone rubber) are marketed in particular by the company C. Otto Gerckens GmbH & Co. KG Dichtungstcchnik, Pinneberg, Germany under the name VMQ.

According to another embodiment, the attachment comprises apparatuses for axial position securing that are designed to support each of the two O-rings in a specific top position and in a specific bottom position and permit a deformation of the two O-rings in the radial direction. As a result, the two O-rings can be held in defined positions or regions on the attachment. These can be tailored to the pipette lips that are to be held on the attachment.

According to another embodiment, the apparatuses for axial position securing are annular grooves. Each annular groove can partially accommodate at least one O-ring, wherein the O-ring is guided at the base of the annular groove on the attachment and is prevented from being shifted upwards and downwards by the two flanks of the annular groove. The annular grooves can be dimensioned so that each O-ring is held in the respective annular groove with an exact fit, or with axial play or somewhat compressed in the axial direction. Furthermore, it is possible to hold both O-rings in the same annular groove. In this case, both O-rings support each other in the same annular groove and the top O-ring is supported on the top flank and the bottom O-ring on the bottom flank of the annular groove.

According to another embodiment, the apparatuses for axial position securing are formed by one or several projections that are arranged on the perimeter of the attachment on both sides of at least one O-ring. A shift in the axial direction is prevented or limited by the at least one projection on both sides of at least one O-ring.

According to a preferred embodiment, each attachment has only two O-rings. According to another embodiment, each attachment has more than two O-rings. For each O-ring, a separate annular groove or other apparatuses for axial position securing can be present, or several O-rings can be arranged together in the same annular groove or be held on the attachment by the same apparatuses for axial position securing.

According to another embodiment, the apparatuses for axial position securing are configured integrally with the attachment. According to another embodiment, the apparatuses for axial position securing are sleeves and/or rings slid onto the attachment that accommodate the O-rings between them that are guided on the inside of the attachment. The sleeves and/or rings are either fixed to the attachment or guided loosely on the attachment and prevented, by additional means for axial position securing, from being stripped off the attachment. These can be formed, for example, by the carrier above and by a securing ring below which is held in an additional annular groove on the perimeter of the attachment.

According to another embodiment, the two O-rings are arranged at a distance from each other on the attachment. This is particularly advantageous for the precise alignment of the pipette tips on the attachment. Furthermore, a particularly gentle increase in the clamping forces when clamping a pipette tip can be achieved in this way.

According to another embodiment, the attachment has at least one conical portion. This is advantageous for clamping pipette tips onto the attachment with a gradual increase in the clamping forces. According to another embodiment, the attachment has at least one cylindrical portion. The cylindrical portion can improve the guidance and the sealing of a pipette tip on the attachment.

According to another embodiment, the attachment has a top cylindrical portion at the top, a bottom cylindrical portion at the bottom, a conical portion tapering from top to bottom between them, and top apparatuses for axial position securing between the top cylindrical portion and the conical portion and bottom apparatuses for axial position securing between the conical portion and the bottom cylindrical portion. As a result, it can be achieved that the clamping forces when clamping the pipette tip onto the attachment increase gradually and the pipette tip is well guided and aligned on the attachment.

According to another embodiment, the top O-ring has a larger inner diameter and/or a cross-section with a larger diameter than the bottom O-ring. This is advantageous for a gradual increase in the clamping forces when clamping a pipette tip onto the attachment.

According to another embodiment, the diameter of the cross-section of the top O-ring is larger than the depth of the top annular groove and/or the width of the top annular groove is the same as or larger than the diameter of the cross-section of the top O-ring and/or the diameter of the cross-section of the bottom O-ring is larger than the height of the bottom annular groove and/or the width of the bottom annular groove is the same as or larger than the diameter of the cross-section of the bottom O-ring. With the depth of the respective annular groove, it is achieved that the respective O-ring can be deformed in the radial direction by clamping a pipette tip onto the attachment and/or with the width of the respective annular groove, a long deformation path is achieved with low clamping forces.

According to another embodiment, the pipetting head has attachments arranged in parallel next to each other in one or several rows. As a result, the pipetting head can be used for simultaneously clamping a large number of pipette tips, for which it is particularly well suited due to the low clamping forces.

According to another embodiment, the attachments are securely connected to the carrier. The two O-rings can keep the clamping forces low so that it is in particular not required for this purpose to support the attachments on the carrier via springs. According to another embodiment of the pipetting head according to the invention, the attachments are supported on the carrier via springs in order to additionally limit the mounting forces as a result.

According to another embodiment, the carrier is a housing or a part of a housing or a chassis or a part of a chassis of the pipetting head. For example, the carrier is a bottom housing wall of the housing or a bottom part of a chassis of the pipetting head. The attachment can be held in particular by screwing into a bottom housing wall or into a bottom part of a chassis. If the attachment is held in a bottom part of a chassis, the housing can have a through-hole for each attachment in a bottom housing wall or the bottom housing wall can be completely missing.

The invention furthermore relates to a pipetting device or a transfer device comprising a pipetting head. The pipetting device or transfer device can be configured in particular as a practical pipetting device or transfer device that is driven manually or by electric motor and has one or several channels, which device can be held in the hand of the user when pipetting or transferring pipette tips (hand-held pipette).

The invention furthermore relates to a pipetting station or a pipetting machine or a laboratory machine comprising a pipetting device and/or a transfer device according to claim 12. The pipetting station or the pipetting machine or the laboratory machine can be used for (automatic) pipetting or transferring of pipette tips. The laboratory machine can be used for automatic pipetting, for transferring pipette tips, and in addition for other procedures with liquids, for example for controlling temperature, mixing, performing chemical or biochemical reactions and other physical, chemical, or biochemical procedures.

In a pipetting station, a pipetting machine, or a laboratory machine, the pipetting head can be configured so that it can be fastened to the pipetting station, the pipetting machine, or the laboratory machine by means of a rapid change device and can be detached therefrom in order to fasten another pipetting head (e.g. for other pipette tip sizes), a gripper tool for transporting labware, or another tool thereon. This embodiment is also referred to as a pipetting tool.

The invention furthermore relates to the use of a pipetting head of a pipetting device, or of a pipetting station or a pipetting machine or a laboratory machine, in which a pipette tip is clamped onto each attachment of the pipetting head. The pipetting head is shifted until each clamped-on pipette tip has contact on its bottom end with a vessel that is provided on a work surface. The pipetting head is shifted until the bottom end of each clamped-on pipette tip is a specific distance away from a floor of the vessel and liquid is drawn from the vessel into each clamped-on pipette tip.

For a plurality of applications, it is desirable to draw the liquid into a pipette tip in close proximity to the floor of a vessel. These applications include, for example, efficient washing steps as well as the optimal recovery of liquids under phase boundaries. In a pipetting station, a pipetting machine, or in a laboratory machine, there are a plurality of tolerances in this context which influence the final positioning of the tip opening in the vertical direction. In particular when using multichannel pipetting heads, in particular in the design with a rapid change device (multichannel pipetting tools), the exact positioning of the individual pipette tips is not possible.

The use of a pipetting head with two O-rings per attachment enables unknown tolerance chains due to small differences in the seat of the pipette tips to be allowed while keeping the metering quality the same. For this purpose, the pipette tips are first picked up by means of a pipetting head with only one or several channels until pipette tips are clamped onto all the attachments. In this case, the pipette tips are not completely slid onto the attachments, i.e. not up to an ejector or a stop, so that they can be pushed farther upwards on the attachments. After that, the pipetting head is shifted and placed with the bottom ends of all the clamped-on pipette tips on the vessel from which liquid is to be removed or into which liquid is to be dispensed. Placing the bottom ends of the pipette tips onto the vessels compensates for known and unknown tolerances. In this case, the pipette tips can be pushed somewhat farther upwards on the attachments, and this to different extents, depending on whether their bottom ends make contact earlier or later with the vessels. Then, all the clamped-on pipette tips are immersed in a vessel until they are a short distance from the floor of the vessel. This generates a small gap for drawing in liquid between the tip opening and the floor of the vessel. The process can take place fully automatically so that no additional effort for the user occurs. The process can take place during a program run of a laboratory machine. The seat of the clamped-on pipette tips can be adapted to the individual vessel receptacles (cavities) of the single or multi-cavity vessels or other disposables used.

According to one embodiment, the pipetting head is shifted until the bottom ends of all the clamped-on pipette tips have contact with the floor of a vessel at the same time, and then the pipetting head is shifted until the bottom ends of all the pipette tips are a specific distance from the floor of the vessel. As a result, a particularly small gap between the bottom ends of the respective clamped-on pipette tips and the floor of the vessels can be achieved. According to another embodiment, the pipetting head is shifted until the bottom ends of all the clamped-on pipette tips have contact with a part of the surface of the vessel other than the floor. As a result, at least a precise alignment of the pipette tips with the vessels is achieved, wherein only tolerances between the position of the contacted surface and the floor of the vessel are not compensated.

According to another embodiment, the pipetting head is a multichannel pipetting head and the vessel is a multi-cavity vessel, in particular a microtest plate (microtiter plate). The invention is particularly suited for the simultaneous compensation of a plurality of tolerances between clamped-on pipette tips and a microtest plate. In this case, the bottom end of each pipette tip is first brought into contact with a surface of the multi-cavity vessel or with the floor of a well or other cavity of the multi-cavity vessel and then to a small distance from the floor of the cavity.

If it is not possible to shift the pipetting head so that the bottom end of each clamped-on pipette tip has contact with a vessel that is provided on a work surface, for example because the vessel is filled with a liquid that must not come into contact with the pipette tip, the pipetting head can be used such that all the pipette tips are pushed upwards up to an ejector or stop on the attachment so that all the clamped-on pipette tips are at the same height. As a result, the errors due to tolerances are reduced, albeit not to the same extent as when shifting the pipetting head such that the bottom ends of the clamped-on pipette tips have contact with the vessel.

An embodiment of a pipetting head for a pipetting device comprises a carrier, at least one attachment held on the carrier for clamping on pipette tips, and two elastomer O-rings held on the attachment. The two O-rings and the attachment are configured to securely clamp a pipette tip on the attachment through deformation of the two O-rings alone. In an embodiment, the O-rings are manufactured from a soft rubber, silicone, or thermoplastic elastomer.

In an embodiment, the attachment has apparatuses for axial position securing which are designed to support each of the two O-rings in a specific top position and in a specific bottom position and to permit a deformation of the two O-rings in the radial direction.

In an embodiment of the pipetting head, the apparatuses for axial position securing are peripheral annular grooves on the perimeter of the attachment which partially accommodate at least one O-ring, or are one or several projections on the perimeter of the attachment which accommodate at least one O-ring between them. In an embodiment of the pipetting head, the attachment has at least one conical portion and/or in which the attachment has at least one cylindrical portion.

In an embodiment of the pipetting head, the attachment has a top cylindrical portion at the top, a bottom cylindrical portion at the bottom, a conical portion tapering from top to bottom between them, and top apparatuses for axial position securing between the top cylindrical portion and the conical portion and bottom apparatuses for axial position securing between the conical portion and the bottom cylindrical portion. In an embodiment of the pipetting head, the top O-ring has a larger inner diameter and/or a cross-section with a larger diameter than the bottom O-ring.

In an embodiment of the pipetting head, the diameter of the cross-section of the top O-ring is larger than the depth of the top annular groove and/or the width of the top annular groove is the same as or larger than the diameter of the cross-section of the top O-ring and/or the diameter of the cross-section of the bottom O-ring is larger than the height of the bottom annular groove and/or in which the width of the bottom annular groove is the same as or larger than the diameter of the cross-section of the bottom O-ring. In an embodiment, the pipetting head has attachments arranged parallel next to each other in one or several rows. In an embodiment, the attachments are securely connected to the carrier.

An embodiment of a pipetting device or transfer device comprises a pipetting head according to one of the previously discussed embodiments. An embodiment of a pipetting station or pipetting machine or laboratory machine comprises a pipetting device and/or a transfer device.

In an embodiment, use of a pipetting head, a pipetting device or transfer device, or of a pipetting station, a pipetting machine, or a laboratory machine, in which a pipette tip is clamped onto each attachment of the pipetting head, the pipetting head is shifted until each clamped-on pipette tip has contact on its bottom end with a vessel that is provided on a work surface, the pipetting head is shifted until the bottom end of each clamped-on pipette tip is a specific distance (x) away from a floor of the vessel, and liquid is drawn from the vessel into each clamped-on pipette tip. In an embodiment, the pipetting head is shifted until the bottom ends of all the clamped-on pipette tips have contact with the floor of the vessel at the same time, and after that the pipetting head is shifted until the bottom ends of all the pipette tips are a specific distance from the floor of the vessel. In an embodiment, the pipetting head is a multichannel pipetting head and the vessel is a microtiter plate.

### BRIEF DESCRIPTION OF THE DRAWINGS

The invention will be further explained below with reference to the accompanying drawings of exemplary embodiments. In the drawings:

FIG. 1 illustrates a front view of an embodiment of a pipetting head with clamped-on pipette tips;

FIG. 2 illustrates a rear view of the embodiment of the pipetting head from FIG. 1 without pipette tips;

FIG. 3 illustrates a sectional view of the embodiment of the pipetting head from FIG. 1;

FIG. 4 illustrates an enlarged sectional view of an embodiment of an attachment of the pipetting head of FIG. 1:

FIG. 5 illustrates a diagram of mounting forces as a function of the path of the pipetting head when clamping onto a conventional pipetting head and onto a pipetting head;

FIG. 6 illustrates a schematic depiction of tolerance chains and sums in a metering system;

FIG. 7 illustrates a schematic depiction of an embodiment of attachments of a multichannel pipetting head with picked-up pipette tips above the floor of a microtiter plate;

FIG. 8 illustrates a schematic depiction of an embodiment of the pipetting tool with pipette tips individually adjusted through making contact with the floor region of the microtiter plate; and

FIG. 9 illustrates a schematic depiction of an embodiment of the pipetting tool with individually adjusted pipette tips retracted to a small distance from the floor region of the microtiter plate.

### DETAILED DESCRIPTION OF THE INVENTION

In this application, the terms “top” and “bottom,” “horizontal” and “vertical” refer to an orientation of the pipetting head with the attachments in a vertical direction, wherein the attachments are arranged at the bottom and the other parts of the pipetting head are arranged above. In the description of different embodiments, the same reference numbers are used for components with the same names.

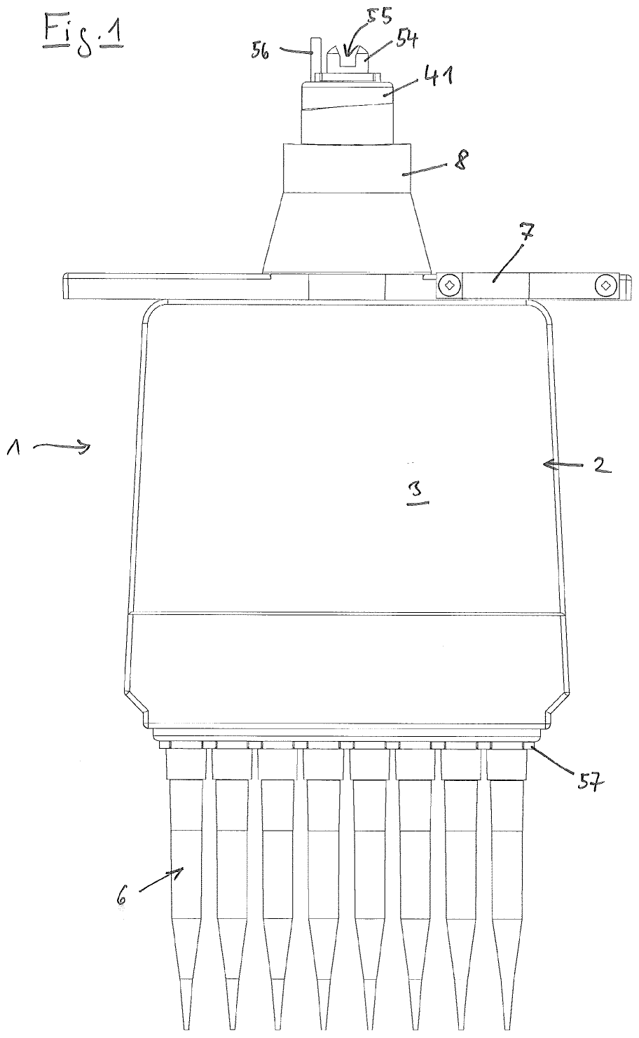

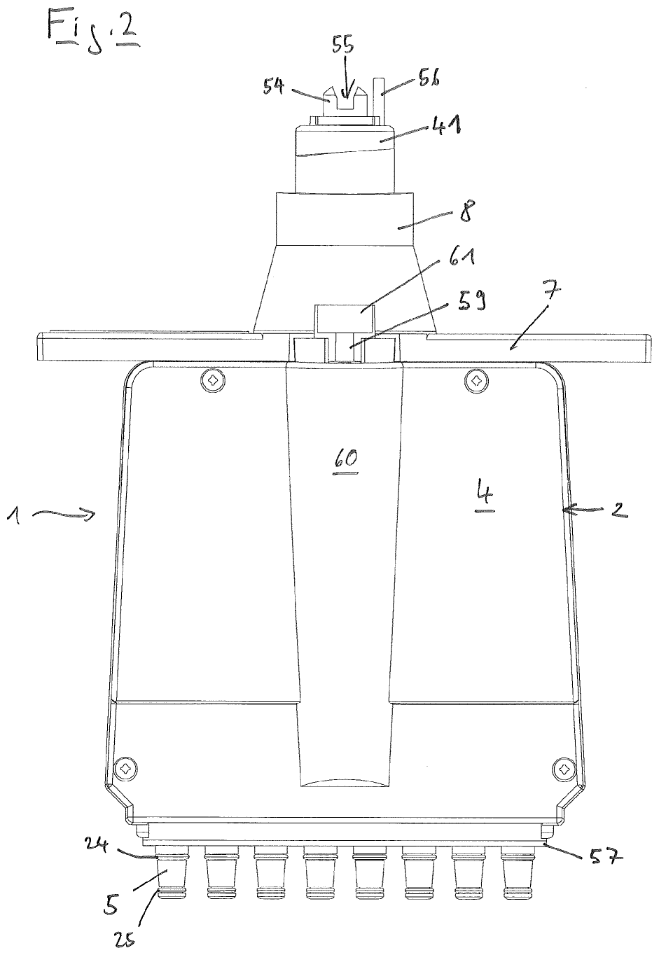

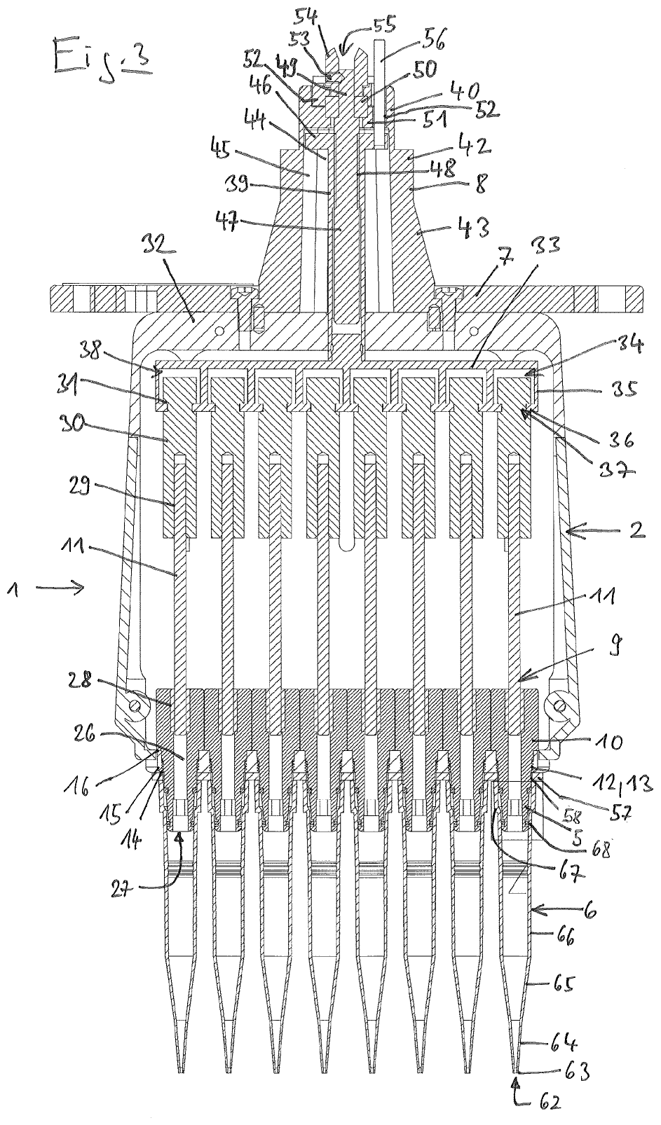

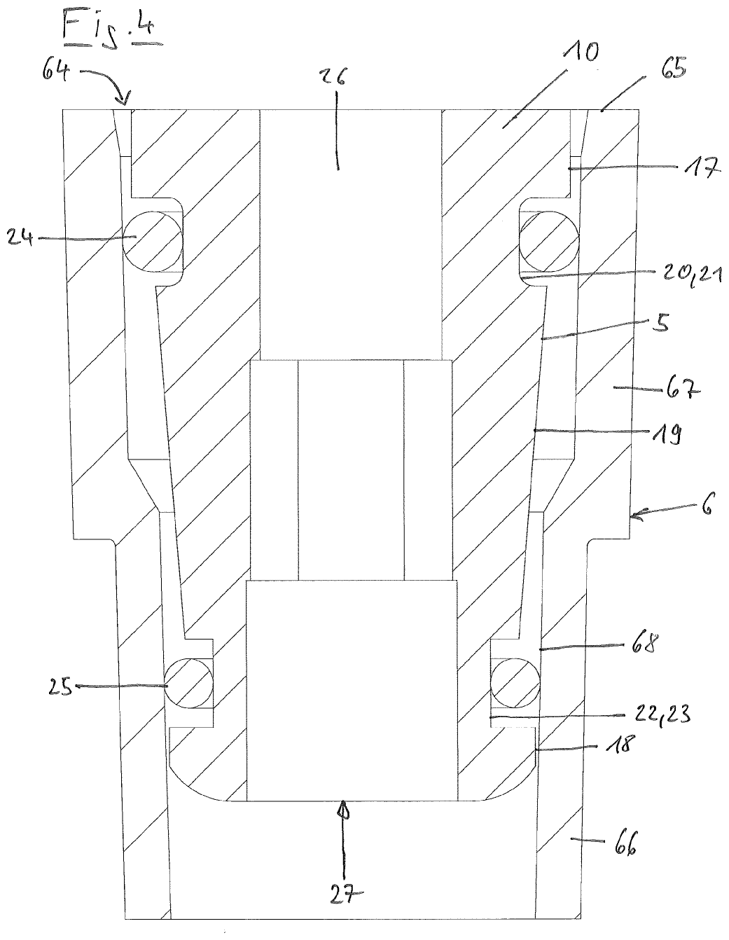

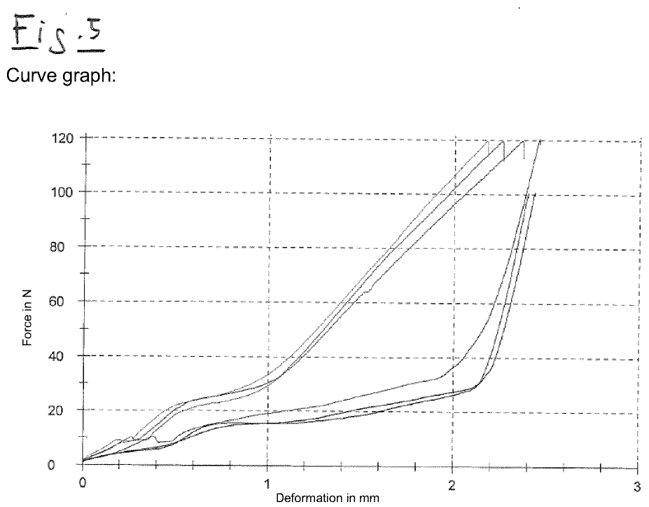

According to FIGS. 1 to 2, the pipetting head 1 comprises a housing 2 that is formed from a front and a rear housing shell 3, 4 that are joined in a vertical plane. Eight parallel attachments 5 (pins) for clamping on pipette tips 6 project vertically downward from the underside of the pipetting head 1 (FIGS. 3 and 4). A strip-shaped carrier plate 7 is arranged on the top side of the housing 2. From the carrier plate 7, a fastening pin 8 projects upward.

According to FIG. 3, eight parallel plunger/cylinder units 9 are arranged next to each other in a row in the pipetting head 1. Each plunger/cylinder unit 9 has one cylinder 10 in which a plunger 11 is movably arranged. Each cylinder 10 has an outer thread 12 with which it is screwed into a corresponding inner thread 13 in a through-hole 14 in a horizontal bottom housing wall 15. Screwing the cylinders 10 into the bottom housing wall 15 is limited by steps 16 on the outer perimeter of the cylinders 10 with which they lie against the top side of the bottom housing wall 15. The bottom part of the cylinders 10 projects outwardly from the underside of the bottom housing wall 15 and forms the attachments 5 there. Housing 2 is thus a carrier for the attachments 5.

According to FIG. 4, each attachment 5 has a top cylindrical portion 17 at the top, a bottom cylindrical portion 18 at the bottom, and a conical portion 19 tapering from top to bottom between them. On each attachment 5, top apparatuses for axial position securing 20 in the form of a top annular groove 21 are present between the top cylindrical portion 17 and the conical portion 19, and bottom apparatuses for axial position securing 22 in the form of a bottom annular groove 23 are present between the conical portion 19 and the bottom cylindrical portion 18.

An O-ring 24, 25 made of an elastomer, preferably a soft elastomer, in particular a soft silicone rubber, is inserted into each annular groove 21, 23. Each O-ring 24, 25 is guided on the base of the annular groove 21, 23 and has a cross-section with a diameter that is larger than the depth of the annular groove 21, 23 and that is smaller than the width of the annular groove 21, 23 in which it is arranged. The interior space 26 of each cylinder 10 into which the plunger 11 is plunged from above extends downward to a connecting hole 27 in the bottom face of the attachment 5.

At the top of each cylinder 10, a liner 28 (FIG. 3) is arranged, through which a plunger 11 is guided into each cylinder 10 in a sealing manner. Referring back to FIG. 3, each plunger 11 is configured as a cylindrical rod which is inserted at the top into a central hole 29 of a cylindrical plunger head 30 and is fastened therein (e.g. adhered or pressed in). Each plunger head 30 has a peripheral plunger head annular groove 31 on the outer perimeter. Below a horizontal top housing wall 32, a strip-shaped plunger plate 33 is arranged parallel thereto. The plunger plate 33 has eight channels 34 on the underside that are open at the bottom and are aligned parallel to each other. Each channel is bordered by two strip-shaped channel walls 35 and by two channel shoulders 36 that project to the inside from the bottom ends of the channel walls. The channel walls 35 on the two outer edges of the plunger plate 33 each border an adjacent channel 34 only on one side. The other channel walls 35 each border two adjacent channels 34 on one side. Between the channel shoulders 36, each channel has one slotted opening 37 on the underside of the plunger plate 33. On the edges of the plunger plate 33 that are aligned parallel to the front side and rear side of the housing 2, the channels 34 have face openings 38. Top portions of the plunger heads 30 are inserted into the channels 34 through the face openings 38 so that the channel shoulders 36 engage the plunger head annular grooves 31 in a form fit. Consequently, the plungers 11 can be shifted together in the cylinders by vertically shifting the plunger plate 33.

In the center of the fastening pin 8, an axially shiftable threaded nut 39 is arranged, the bottom end of which is securely connected to the plunger plate 33 in order to shift the plunger plate 33 in the axial direction of the cylinders 10. The fastening pin 8 has a cylindrical top pin portion 40 at the top. On the outer perimeter, the top pin portion 40 bears two partially peripheral connecting elements 41 that are offset to each other by 180° and project radially to the outside and with which a bayonet connection can be formed. The connecting elements 41 have a slight thread pitch at the bottom side to be tightened with a fitting connecting element in a pin holder of a bayonet connection.

Adjacent to the top pin portion 40, the fastening portion 8 has a cylindrical, middle pin portion 42 with a larger outer diameter than the top pin portion 40. Underneath, the fastening pin 8 has a bottom pin portion 43 that expands conically downward. The bottom pin portion 43 is connected securely at its base to the carrier plate 7. A central hole 44 extends in the longitudinal direction of the fastening pin 8. Said hole has two diametrically opposed longitudinal grooves 45.

The sleeve-like threaded nut 39 is inserted in the central hole 44 and is guided by two radially projecting wings 46 at its top end in the longitudinal grooves 45. Furthermore, a spindle 47 is screwed into the threaded nut 39. Above its thread 48, said spindle has a projecting bearing pin 49 by which it is mounted in a ball bearing 50. The ball bearing 50 is held in a bearing bushing 51 of a bearing carrier 52 that has two tabs that project diametrically from the sides and lie on the top edge of the top pin portion 40 and are fixed thereto by means of screws. On the part of the bearing pin 49 that projects beyond the ball bearing 50, a driver 54 is fixed non-rotatably by means of a radial threaded pin 53 and has a slot 55 extending radially and axially in its top face for introducing a pawl-like drive unit. The spindle 47 is supported on the bottom face of the ball bearing 50. The driver 54 is supported on the top face of the ball bearing 50. The spindle 47 is held hereby in the fastening pin 8 so as to not be axially shiftable. In one wing 46 of the threaded nut 39, a cylinder pin 56 is fixed that is guided through a groove in the bearing carrier 52 oriented parallel to the middle axis of the threaded nut 39 and projects upward out of the fastening pin 8.

By rotating the driver 54, the spindle 47 that is axially fixed in the fastening pin 8 moves the threaded nut 39 that is non-rotatably guided in the fastening pin 8 in an axial direction. This shifts the plunger plate 33 and the plungers 11 are shifted in the cylinders 10. By rotating the driver 54 in different directions, the plungers 11 can be shifted in different directions in the cylinders 10. By scanning the position of the cylinder pin 56, it is possible to determine the respective position of the plungers 11 in the cylinders 10.

The fastening pin 8 and the drive integrated therein with the threaded nut 39 and spindle 47 correspond to the embodiments in FIGS. 1 to 4 as well as FIG. 6 according to EP 1 407 861 B1. In this regard, reference is made to the document EP 1 407 861 B1, the content of which is hereby incorporated by reference into this application.

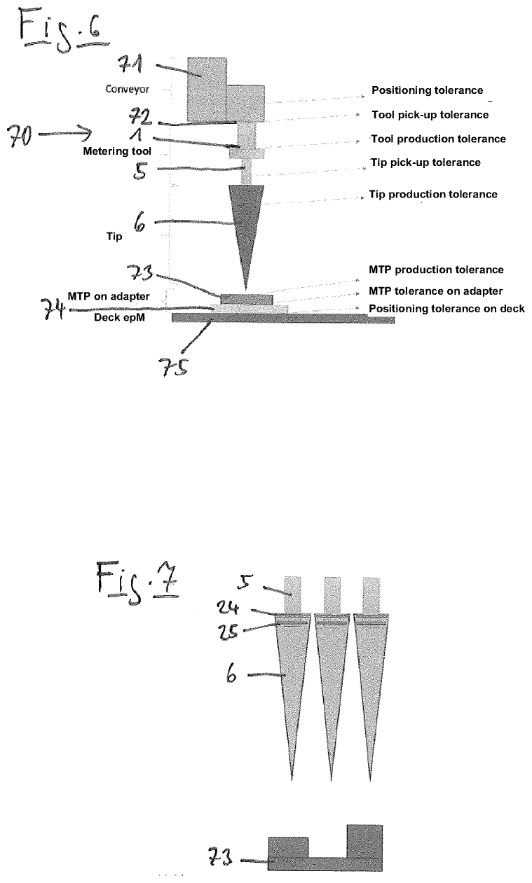

A laboratory machine is provided with a complementary pin holder of a bayonet connection that is connectable to the fastening pin. Preferably, the complementary connecting part of the laboratory machine corresponds to the tool holder according to FIGS. 7 to 10 of EP 1 407 861 B1. In this regard, reference is made to the document EP 1 407 861 B1, the content of which is hereby incorporated by reference into this application.

Below the bottom housing wall 15, a stripping plate 57 is arranged that has further through-holes 58 through which the pins 5 project downward. The stripping plate 57 is connected on a longitudinal side to a rod assembly 59 which is guided upward in a convexity 60 of the rear housing shell 4 which has an opening at the top through which the rod assembly 59 protrudes out of the housing 2. A driver 61 (FIG. 2) projects laterally from the top end of the rod assembly 59. By means of a spring apparatus (not shown), the rod assembly 59 is pressed upward in the resting state until the stripping plate 57 lies against the underside of the bottom housing wall 15. The laboratory machine has a drive with a drive element with which the driver 61 (FIG. 2) can be pressed downward, as a result of which the stripping plate 57 is entrained downward to strip the pipette tips 6 from the attachments 5.

According to FIGS. 3 and 4, pipette tips 6 are clamped onto the attachments 5. The pipette tips 6 are tubes with a tip opening 62 at the bottom end 63 and a mounting opening 64 at the top end 65. The inner diameter and the outer diameter of the pipette tip 6 generally expand from the tip opening 62 to the mounting opening 64. In the example, the pipette tips 6 have several conical regions 64, 65, 66 as well as a cylindrical expansion 67 in the proximity of the top end 65. In the region of the cylindrical expansion 67 and in the region beneath it, the pipette tip has a sealing seat 68 in the interior.

According to FIGS. 3 and 4, the attachments 5 of the pipetting head 1 are introduced through the mounting openings 64 into the pipette tips 6. The O-rings 24, 25 are arranged at the height of the sealing seat 68. This presses together the O-rings 24, 25 somewhat in the radial direction so that the pipette tips 6 securely clamp on the attachments 5 and are sealed against the attachments 5. Since the O-rings 24, 25 consist of a soft-clastic material and the pipette tips 6 otherwise have no contact with the attachments 5, the mounting forces when mounting the pipette tips 6 on the attachments 5 are relatively small.

In FIG. 5, the measured mounting forces when mounting pipette tips as a function of the path of the pipetting head are shown next to each other for a pipetting head 1 according to the invention with eight channels and two O-rings 24, 25 on each attachment 5 and a conventional pipetting head with eight channels without O-rings 24, 25 on the attachments. According to the three curves on the left in the diagram, when using a conventional pipetting head, the mounting forces increase sharply until they are sitting on the attachments in a sufficiently secure and sealing manner. This is given at a mounting force of 120 Newton and with a shift of the pipetting head of 2.2 mm. According to the curves plotted on the right in the diagram, a sufficiently secure and sealed connection is established at mounting forces of approx. 30 Newtons and a shift of the pipetting head of 2 mm. In this case, only the O-rings 24, 25 are elastically deformed. Above this value, the mounting forces increase sharply since a deformation of the pipette tips 6 is also required for this. Due to the reduced mounting forces, the forces for ejecting the pipette tips 6 from the attachments 5 are also reduced.

In the following, the use according to the invention will be explained on the basis of FIGS. 6 to 9. According to FIG. 6, a laboratory machine 70 has a plurality of tolerances which influence the positioning of the tip opening 64 of pipette tips 6 in the vertical direction. These tolerances include the tolerances of the positioning of a multi-axis transferring device 71 (robot arm or other transferring system). Added to these are the tolerances of fixing a pipetting head 1 (pipetting tool) in the tool holder 72 held on the multi-axis transferring device 71. Furthermore, manufacturing tolerances of the pipetting head 1 must also be taken into account. In addition, the attachments 5 for picking up the pipette tips 6 and the pipette tips 6 themselves have tolerances. Microtiter plates 73 and adapters 74 for positioning the microtiter plates 73 on a work surface 75 (deck) of the laboratory machine 70 have additional tolerances. Finally, the work surface 75 itself also has tolerances.

In particular when using multichannel pipetting heads 1, the exact positioning of the individual pipette tips 6 is not possible since an equal height must be used for all the pipette tips 6. In many target applications, such as for example next-generation sequencing (NGS), this leads to losses in quality due to decreased efficiency of the washing steps and/or decreased yields from test material. In the worst case, contamination is carried over, e.g., if a sample is to be aspirated below another phase (e.g. samples covered with oil) and portions of the overlay are carried over.

The reduction of tolerance ranges leads to lower process reliability and therefore to an increased risk of sample loss. In addition, it only partially solves the problem, since specific tolerance ranges must not be undershot. Often, the direct need for a very precise calibration of the device in order to minimize individual tolerances also increases.

“Surface teaching” addresses specific tolerances on the system (e.g., positioning offset and tool tolerance), but it is very work-intensive for the user and requires a large amount of effort. Additionally, a plurality of tolerances are also not covered by surface teaching (e.g., well geometry, microtiter plate seat on adapter, pipette tip geometry, pipette tip seat, tool holder, etc.), since these do not take place during the metering process but in advance of use.

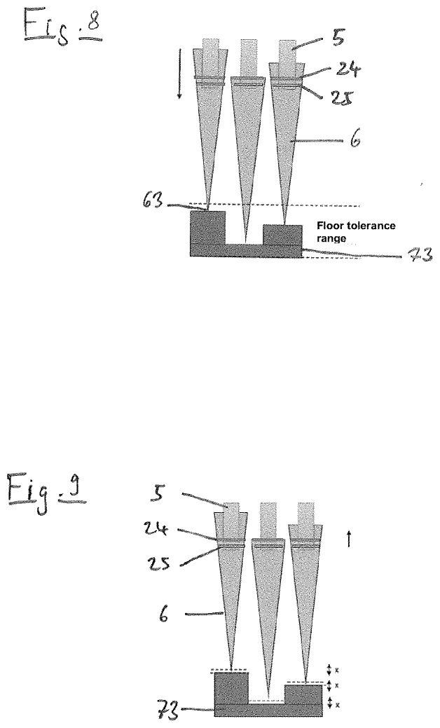

The use of two O-rings 24, 25 on each attachment 5 enables unknown tolerance chains due to small differences in the seat of the pipette tips to be allowed while keeping the metering quality the same. The method consists of three substeps: (1) Several pipette tips 6 are picked up on a single- or multichannel pipetting head 1 (FIG. 7); (2) After the pipette tips 6 have been picked up on the attachments 5 of the pipetting head 1, all the pipette tips 6 are located at a comparable height and can be slid an additional distance onto the attachments 5 with a small exertion of force; and (3) Through a dedicated movement in the vertical direction under the floor tolerance range of a surface (e.g., the floor of a microtiter plate 73), the pipette tips 6 are pressed onto the respective attachments 5 to different extents. With the same alignment of the attachments 5 in the vertical direction, after this step the individual pipette tips 6 have individual heights, which have been determined by the unknown floor geometry and the tolerance chains. This is shown in FIG. 8.

After that, a small upward movement of the pipetting head 1 generates a gap x between the bottom ends 63 of the pipette tips 6 and the surface of the vessel (e.g., microtiter plate 73). This gap x is required for aspiration of liquid into the pipette tips 6 to avoid blocking the pipette tips 6. According to this method, due to the individual positioning of the pipette tips 6, the bottom ends of all the pipette tips 6 are the same distance from the surface of the vessel. This is shown in FIG. 9.

The advantage of this method is that all (known and unknown) tolerances can be completely compensated at each metering step. Furthermore, this process takes place automatically, since it can be executed by the laboratory machine 70 without additional effort for the user. The method is performed during a run of the laboratory machine 70 with the individual combinations of pipette tips 6 and the corresponding individual cavities of single- and multi-cavity vessels used (e.g., microtiter plates 73).

### LIST OF REFERENCE SIGNS

1 Pipetting head
2 Housing (carrier)
3,4 Housing shell
5 Attachment (pin)
6 Pipette tip
7 Fastening plate (carrier plate)
8 Fastening pin
9 Plunger/cylinder unit
10 Cylinder
11 Plunger
12 Outer thread
13 Inner thread
14 Through-hole
15 Housing wall
16 Step
17 Top cylindrical portion
18 Bottom cylindrical portion
19 Conical portion
20 Top apparatuses for axial position securing
21 Top annular groove
22 Bottom apparatuses for axial position securing
23 Bottom annular groove
24, 25 O-rings
26 Interior space
27 Connecting hole
28 Liner
29 Hole
30 Cylindrical plunger head
31 Plunger head annular groove
32 Housing wall
33 Plunger plate
34 Channels
35 Channel wall
36 Channel shoulder
37 Slotted opening
38 Face opening
39 Threaded nut
40 Top pin portion
41 Connecting element
42 Middle pin portion
43 Bottom pin portion
44 Hole
45 Longitudinal groove
46 Wing
47 Spindle
48 Thread
49 Bearing pin
50 Ball bearing
51 Bearing bushing
52 Bearing carrier
53 Threaded pin
54 Driver
55 Slot
56 Cylindrical pin
57 Stripping plate
58 Through-hole
59 Rod assembly
60 Protrusion
61 Driver
62 rip opening
63 Bottom end
64 Mounting opening
65 Top end
64, 65, 66 Conical regions
67 Cylindrical expansion
68 Scaling seat
70 Laboratory machine
71 Multi-axis transferring device (robot arm)
72 Tool holder
73 Microtiter plate
74 Adapter
75 Work surface

1-16. (canceled)

17. A pipetting head with at least one pipette tip for a pipetting device, the pipetting head comprising:
a carrier;
at least one attachment held on the carrier and configured to receive and secure the at least one pipette tip, wherein the at least one pipette tip comprises a sealing seat defining an inner diameter; and
two O-rings retained on the at least one attachment and configured to contact the sealing seat of the at least one pipette tip,
wherein the inner diameter of a sealing seat of the at least one pipette tip is smaller than an outer diameter of a respective O-ring where the sealing seat contacts a respective O-ring such that the respective O-ring is deformed while the at least one pipette tip is slid onto the at least one attachment to securely clamp the at least one pipette tip on the at least one attachment, and
wherein the sealing seat of the at least one pipette tip is dimensioned such that the at least one attachment exerts a force on the at least one pipette tip when the sealing seat contacts the at least one attachment, and wherein the force is configured to deform the at least one pipette tip when the at least one pipette tip is securely clamped on the at least one attachment.

18. The pipetting head according to claim 17, wherein the two O-rings are comprised of an elastomeric material.

19. The pipetting head according to claim 18, wherein the elastomeric material is one of a soft rubber, silicone, and a thermoplastic elastomer.

20. The pipetting head according to claim 18, wherein the at least one attachment comprises apparatuses configured for axial position securing and to support one of the two O-rings in a top position and another of the two O-rings in a bottom position, and wherein the apparatuses configured for axial position securing enable deformation of the two O-rings in a radial direction.

21. The pipetting head according to claim 20, wherein the apparatuses configured for axial position securing are peripheral annular grooves defined on a perimeter of the at least one attachment and are configured to partially accommodate at least one of the two O-ring.

22. The pipetting head according to claim 20, wherein the apparatuses configured for axial position securing are one or more projections on a perimeter of the at least one attachment configured to at least partially accommodate at least one of the two O-ring between them.

23. The pipetting head according to claim 17, wherein the at least one attachment comprises at least one conical portion and at least one cylindrical portion.

24. The pipetting head according to claim 22 wherein the at least one attachment further comprises:
a top cylindrical portion positioned at a top end of the at least one attachment;
a bottom cylindrical portion positioned at a bottom end of the at least one attachment;
a conical portion position between the top and bottom cylindrical portions;
top apparatuses configured for axial position securing positioned between the top cylindrical portion and the conical portion (19); and
bottom apparatuses configured for axial position securing between the conical portion and the bottom cylindrical portion.

25. The pipetting head according to claim 24, wherein the conical portion tapers from the top cylindrical portion to the bottom cylindrical portion.

26. The pipetting head according to claim 17, wherein one of the two O-rings comprises at least one of: (1) a larger inner diameter than another of the two O-rings; and (2) a cross-section with a larger diameter than the other of the two O-rings.

27. The pipetting head according to claim 20, wherein a first of the two O-rings is positioned towards a top of the attachment and a second of the two O-rings is positioned towards a bottom of the attachment relative to the first O-ring, wherein at least one of: (1) a diameter of a cross-section of the first O-ring is larger than a depth of a top annular groove; (2) a width of the top annular groove is at least a same size as the diameter of the cross-section of the top O-ring; (3) a diameter of a cross-section of the second O-ring is larger than a height of a bottom annular groove; and (4) a width of the bottom annular groove is at least a same size as the diameter of the cross-section of the bottom O-ring.

28. The pipetting head according to claim 17, wherein the attachments are arranged parallel and adjacent to each other in one or more rows.

29. The pipetting head according to claim 17, wherein the attachments are securely connected to the carrier.

30. A method for using a pipetting head, the method comprising:
clamping a plurality of pipette tips onto a plurality of attachments of the pipetting head;
shifting the pipetting head until a bottom end of each of the plurality of pipette tips contacts a vessel positioned on a work surface;
shifting the pipetting head until the bottom end of each of the plurality of pipette tips is a specific distance away from a floor of the vessel; and
drawing liquid from the vessel into each of the plurality of pipette tips.

31. The method according to claim 30, wherein the pipetting head is shifted until the bottom end of each of the plurality of pipette tips contacts the floor of the vessel at a same time, and wherein the pipetting head is then shifted until the bottom end of each of the plurality of pipette tip is a specific distance from the floor of the vessel.

32. The method according to claim 30, wherein the pipetting head is a multichannel pipetting head and the vessel is a microtiter plate.
